(19) United States
(12) Patent Application Publication
(10) Pub. No.: US 2014/0216781 A1
(43) Pub. Date: Aug. 7, 2014

(54) SIGNAL TRANSMISSION LINE AND CABLE

(71) Applicant: Sercomm Corporation, Tapei (TW)

(72) Inventors: Yu-Li Shen, Taipei (TW); Yi-Ping Ho, New Taipei City (TW); Ming-Li Tsai, Taipei City (TW)

(73) Assignee: Sercomm Corporation, Tapei (TW)

(21) Appl. No.: 14/045,815

(22) Filed: Oct. 4, 2013

(30) Foreign Application Priority Data
Feb. 5, 2013 (CN) 201320068050.4

(51) Int. Cl. H01B 7/04

(52) U.S. Cl. CPC H01B 7/04
USPC 174/102 R

(57) ABSTRACT

A cable and a signal transmission line applied to Universal Serial Bus (USB) are provided. The cable includes a host connector, a device connector and the signal transmission line. The host connector is selectively electrically coupled to a host. The device connector is selectively electrically coupled to a device. The signal transmission line is electrically coupled between the host connector and the device connector. The signal transmission line includes multiple high speed wires, multiple super speed wires, a power wire, a ground wire and an external conductive layer. The high speed wires, the super speed wires, the power wire and the ground wire form a bundle, and the external conductive layer envelops the bundle.

This application claims the benefit of People's Republic of China application Serial No. 201320068050.4, filed on Feb. 5, 2013, the subject matter of which is incorporated herein by reference.

### BACKGROUND OF THE INVENTION

1. Field of the Invention

The invention relates in general to a signal transmission line and a cable, and more particularly to a Universal Serial Bus (USB) signal transmission line and a USB cable.

2. Description of the Related Art

Universal Serial Bus (hereinafter, USB) is an input/output interface for connecting a computer system with an external device. USB is extensively applied in communication products such as personal computers and mobile devices to extend their functions. USB devices are further applied to other associated fields including camera devices, digital televisions (set-top boxes) and game consoles etc.

As the capacity of a hard drive expands and the amount and standards on high-definition images and videos demanded by people get larger and higher, the current USB 2.0 structure no longer fulfills users needs. Therefore, the USB 3.0 standard is developed and launched with backward compatibility. USB 3.0 adopts a Super Speed transmission mode achieving a maximum data transfer speed of 5 Gbits/second.

FIG. 1 shows a diagram of a cable according to the USB 3.0 standard. Based on compatibility considerations, USB 3.0 adopts a connector 11 compatible to that of the USB 2.0 standard. Apart from wires backward compatible to USB 2.0, a signal transmission line 15 of the USB 3.0 standard also includes newly added wires. Because a USB 3.0 signal transmission line includes more wires, an overall thread diameter of a USB 3.0 signal transmission line is much larger than that of a USB 2.0 signal transmission line.

FIG. 2 shows a sectional view of a USB 3.0 compliant signal transmission line. In the USB 3.0 signal transmission line, a power wire (PWR), a ground wire (GND_PWRrt), and an unshielded twisted pair (UTP) (UTP_Group) formed by a high speed positive wire (UTP_D+) and a high speed negative wire (UTP_D−) are USB 2.0 compatible wires.

Further, to provide transmission and reception with independent channels, USB 3.0 adopts a dual simplex bus architecture. That is, through two shielded differential pair (SDP) groups, the USB 3.0 signal transmission line 15 is capable of simultaneously and bi-directionally transferring data. The two SDP groups are a super speed transmitting wire group (SDP1_Group) for transmission, and a super speed receiving wire group (SDP2_Group) for reception.

The super speed transmitting wire group (SDP1_Group) includes a super speed positive transmitting wire (SDP1+), a super speed negative transmitting wire (SDP1−), and a super speed transmitting shielded wire (SDP1_Drain), which are adjacent to one another. The super speed positive transmitting wire and the super speed negative transmitting wire form a first full duplex differential pair, and the super speed transmitting shielded wire serves as a ground for the first full duplex differential pair. The super speed transmitting wire group (SDP1_Group) transmits data of a host to a device according to the USB 3.0 standard.

The super speed receiving wire group (SDP2_Group) includes a super speed positive receiving wire (SDP2+), a super speed negative receiving wire (SDP2−), and a super speed receiving shielded wire (SDP2_Drain), which are adjacent to one another. The super speed positive receiving wire and the super speed negative receiving wire form a second full duplex differential pair, and the super speed receiving shielded wire serves as a ground for the second full duplex differential pair. The super speed receiving wire group (SDP2_Group) receives data from a device to a host according to the USB 3.0 standard. The super speed transmitting and the super speed receiving shielded wires serve as drain wire termination, control electromagnetic interference (hereinafter, EMI), and maintain signal integrity.

As seen from the diagram, except multiple wires and fillers 155a, 155b, 155c and 155d at the innermost layer, the layers, from the outermost layer inwards, are a jacket 151 made of polyvinyl chloride (PVC) and a braid 153, respectively.

Compared to a USB 2.0 signal transmission line utilizing merely four wires, a USB 3.0 signal transmission line utilizes ten wires. Further, each of the jacket 151, the braid 153, the fillers 155a, 155b, 155c and 155d has a non-negligible thickness. Hence, an outer diameter (DM) of a USB 3.0 cable is as much as 5.0 mm. However, when storing or organizing a signal transmission line, a user is often required to wind or fold the signal transmission line, in a way that a signal transmission line having a large diameter may cause storage inconveniences.

FIG. 3 shows a schematic diagram of a wireless network interface controller (NIC) 30, having a hinge structure, implemented jointly with a USB 3.0 type A host connector 31.

To improve radiation field pattern of an antenna, the wireless NIC 30 is usually designed with a hinge 35 for rotating function circuits of wireless networking. That is, by turning the hinge 35, a main body of the function circuits can be located perpendicular to the host connector 31. The wireless NIC 30 with such structure allows the antenna to have a more ideal radiation field pattern.

However, with a structure as the sectional structure in FIG. 2, the signal transmission can barely implemented in the structure in FIG. 3 as the thread diameter of the signal transmission line is too large. In other words, a USB 3.0 signal transmission line of the related art is too bulky and unmanageable.

### SUMMARY

According to an aspect of the present disclosure, a signal transmission line connected to a host via a host connector is provided. The signal transmission line includes: multiple high speed wires, for transceiving data by half duplex via the host connector; multiple super speed wires, parallel to the high speed wires, for transceiving data by full duplex via the host connector; a power wire, parallel to the high speed wires and the super speed wires; a ground wire, parallel to the high speed wires and the super speed wires, wherein the high speed wires, the super speed wires, the power wire and the ground wire jointly form a bundle; and an external conductive layer, enveloping the bundle.

According to another aspect of the present disclosure, a cable applied to USB is provided. The cable includes: a host connector, selectively electrically coupled to a host; a device connector, selectively electrically coupled to a device; and a signal transmission line, having one end electrically coupled to the host connector and the other end electrically coupled to the device connector. The signal transmission line includes: multiple high speed wires, for transceiving data by half duplex; multiple super speed wires, parallel to the high speed wires, for transceiving data by full duplex; a power wire, parallel to the high speed wires and the super speed wires; a ground wire, parallel to the high speed wires and the super speed wires, wherein the high speed wires, the super speed wires, the power wire and the ground wire jointly form a bundle; and an external conductive layer, enveloping the bundle.

The above and other aspects of the disclosure will become better understood with regard to the following detailed description of the preferred but non-limiting embodiments. The following description is made with reference to the accompanying drawings.

### BRIEF DESCRIPTION OF THE DRAWINGS

FIG. 1 (prior art) is a diagram of a cable according to the USB 3.0 standard;

FIG. 2 (prior art) is a sectional view of a USB 3.0 compliant signal transmission line;

FIG. 3 (prior art) is a schematic diagram of a wireless network interface controller (NIC), having a hinge structure, implemented with a USB 3.0 type A host connector;

FIG. 4A is a schematic diagram of a structure selected for first-type wires according to an embodiment of the present disclosure;

FIG. 4B is a schematic diagram of a structure selected for second-type wires according to an embodiment of the present disclosure;

FIG. 5 is a sectional view of a signal transmission line applied for a USB 3.0 cable;

FIG. 6A is a schematic diagram of a signal transmission line applied with a standard type A host connector according to one embodiment of the present disclosure;

FIG. 6B is a schematic diagram of a signal transmission line according to an embodiment of the present disclosure;

FIG. 6C is a schematic diagram of a signal transmission line applied with a micro B device connector according to one embodiment of the present disclosure;

FIG. 7 is a schematic diagram of a signal transmission line that can be easily put to storage; and

FIG. 8 is a schematic diagram of selectable thread diameter ranges for a cable according to the USB 3.0 standard.

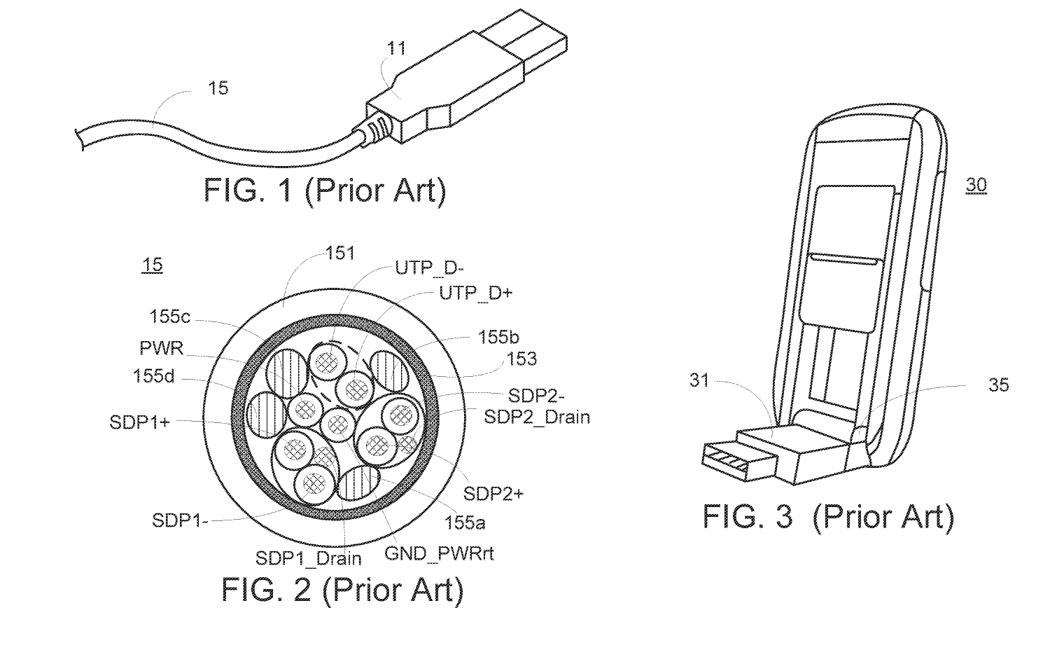

### DETAILED DESCRIPTION OF THE INVENTION

The following embodiments are disclosed for overcoming an issue of unsatisfactory manageability of a USB 3.0 cable having a large diameter for a portable device in the related art.

In one embodiment, wires in a signal transmission line are categorized into a first type that is compatible with USB 2.0, and a second type that is newly added according to the USB 3.0 standard. The first-type wires include a power wire (PWR), a ground wire (GND_PWRst), a high speed positive wire (UTP_D+) and a high speed negative wire (UTP_D−). The second-type wires include two super speed wire groups, that is, a super speed transmitting wire group (SDP1_Group) and a super speed receiving wire group (SDP2_Group).

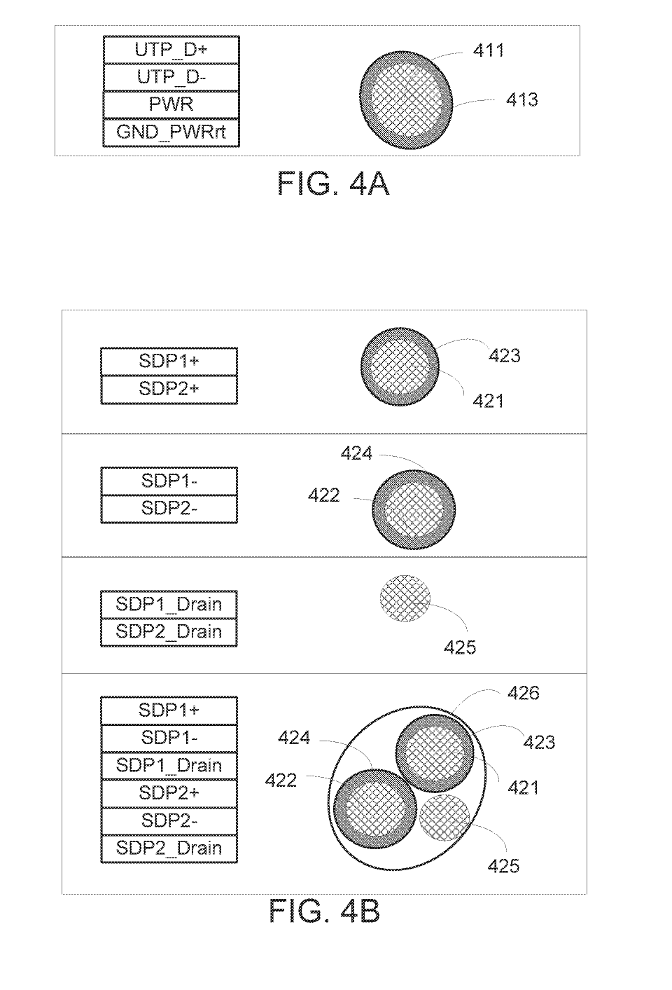

After categorizing the wires in the signal transmission line, different structures are selected and adopted according to the type of wires. FIG. 4A shows a schematic diagram of a structure selected for the first-type wires according to an embodiment of the present disclosure. An innermost part of the power wire (PWR), the ground wire (GND_PWRrt), the high speed positive wire (UTP_D+) and the high speed negative wire (UTP_D−) is a core made of a conductive material (e.g., silver or copper).

For the first-type wires, an outer side of the core is a cover made of an insulation material. For example, the insulation material may be a PVC material such as polyethylene (PE).

For the second-type wires, each of the super speed wire groups includes a super speed positive wire, a super speed negative wire and a super speed ground wire. FIG. 4B depicts an individual super speed wire group as an example for illustrating structures of a super speed positive wire, a super speed negative wire and a super speed ground wire.

FIG. 4B shows a schematic diagram of a structure selected for the second-type wires according to an embodiment of the present disclosure. In the diagram, the first row depicts the structure of the super speed positive wire of a super speed wire group. An innermost part of a super speed positive transmitting wire (SDP1+) and a super speed positive receiving wire (SDP2+) is a core 421 made of a conductive material (e.g., silver or copper). An outer ti side of the core 421 of the super speed positive transmitting wire (SDP1+) and the super speed positive receiving wire (SDP2+) is covered by a cover 423 made of an insulation material.

In the diagram, the second row depicts the structure of the super speed negative wire of the super speed wire group. An innermost part of a super speed negative transmitting wire (SDP1−) and a super speed negative receiving wire (SDP2−) is a core 422 made of a conductive material (e.g., silver or copper). An outer side of the core 422 of the super speed negative transmitting wire (SDP1−) and the super speed negative receiving wire (SDP2−) is covered by a cover 424 made of an insulation material.

In the diagram, the third row depicts the structure of the ground wire of the super speed transmitting wire group (SDP1_Group) or the super speed receiving wire group (SDP2_Group). By comparing the third row with the first and the second rows, it is observed that a super speed transmitting shielded wire (SDP1_Drain) and a super speed receiving shielded wire (SDP2_Drain) do not include a cover. That is, the super speed transmitting shielded wire (SDP1_Drain) and the super speed receiving shielded wire (SDP2_Drain) include only the core.

In the diagram, the fourth row depicts that the present disclosure further provides an inner conductive layer 426 enveloping the super speed transmitting wire group (SDP1_Group) and the super speed receiving wire group (SDP2_Group). That is, the positive wires, the negative wires and the ground wire are enveloped by the inner conductive layer 426.

More specifically, the super speed positive transmitting wire (SDP1+), the super speed negative transmitting wire (SDP1−) and the super speed transmitting shielded wire (SDP1_Drain) are commonly covered by a first internal conductive layer. Similarly, the super speed positive receiving wire (SDP2+), the super speed negative receiving wire (SDP2−) and the super speed receiving shielded wire (SDP2_Drain) are commonly covered by a second internal conductive layer. In practice, the first and the second internal conductive layers provide a shielding function, and may be made of a metal layer such as aluminum foil or copper foil, or a conductive tape.

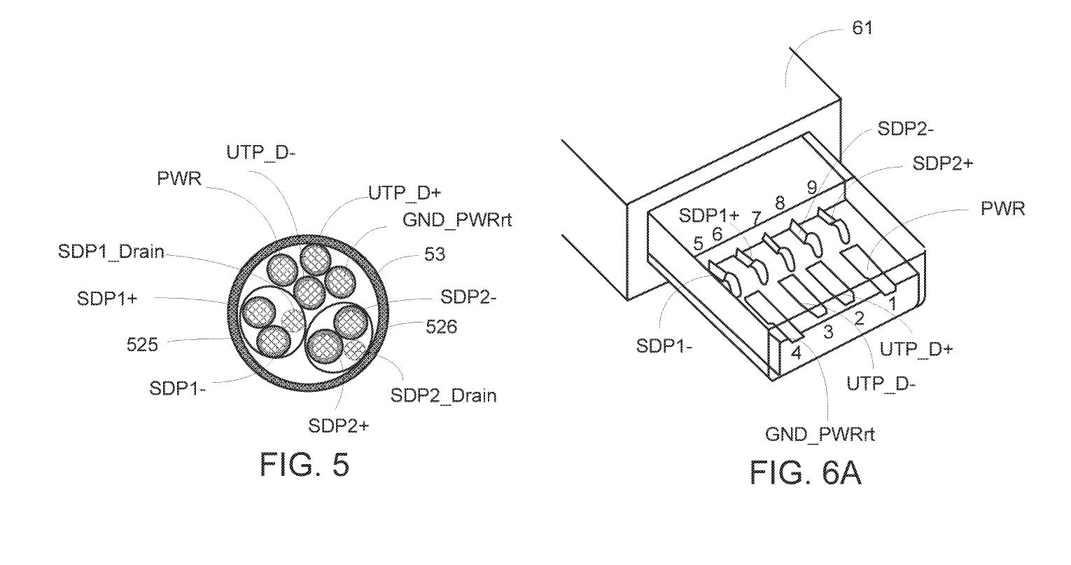

FIG. 5 shows a sectional view of a signal transmission line applied to a USB 3.0 cable according to an embodiment of the present disclosure. As previously stated, the super speed transmitting wire group (SDP1_Group) is covered by a first internal conductive layer 525. Except the high speed transmitting shielded wire (SDP1_Drain) having only a core, each of the remaining wires in the super speed transmitting wire group (SDP1_Group) includes both a core and a cover. Similarly, the super speed receiving wire group (SDP2_Group) is covered by a second internal conductive layer 526. Except the high speed receiving shielded wire (SDP2_Drain) having only a core, each of the remaining wires in the super speed receiving wire group (SDP1_Group) includes both a core and a cover.

In the diagram, an outermost layer of the signal transmission line is covered by an external conductive layer 53. For example, the external conductive layer may be a conductive tape, or a conductive metal layer such as gold foil, copper foil, or silver foil. A conductive tape is formed from polyester having fibers coated with nickel (Ni) and copper (Cu). The nickel layer may be further coated with copper having a high conductivity. Alternatively, a layer of anti-etching nickel may be selectively electroplated onto the copper layer. Further, the outermost layer of the conductive tape may be selected from gold (Au) or silver (Ag). According to an embodiment of the present disclosure, a conductive tape having a composite material formed from metal and fiber, or a metal layer, may be utilized as the outermost layer of the signal transmission line.

When applying a conductive tape to the USB 3.0 signal transmission line, with the shielding effect provided by the metal as well as the lightweight and easy-cutting fiber, the braid and the jacket of the related art can be replaced. Further, a metal layer having a smaller thickness also achieves the shielding effect and a reduced volume of an outer wall. Comparing FIGS. 2 and 5, it is clearly observed that the above embodiments significantly reduce an outer diameter of a USB 3.0 signal transmission line.

By implementing the concept of the present disclosure, an outer diameter of a USB 3.0 signal transmission line can be reduced to approximately 1.7 mm. Thus, the signal transmission line becomes flexible and bendable.

In general, a host connector (type A connector) of a signal transmission line refers to one end applied for connecting to a host such as a personal computer. A device connector (type B connector) refers to one end of a USB cable for connecting to a device such as a mobile product. Details of how a signal transmission line is applied with a host connector and a device connector according to an embodiment of the present disclosure are given below,

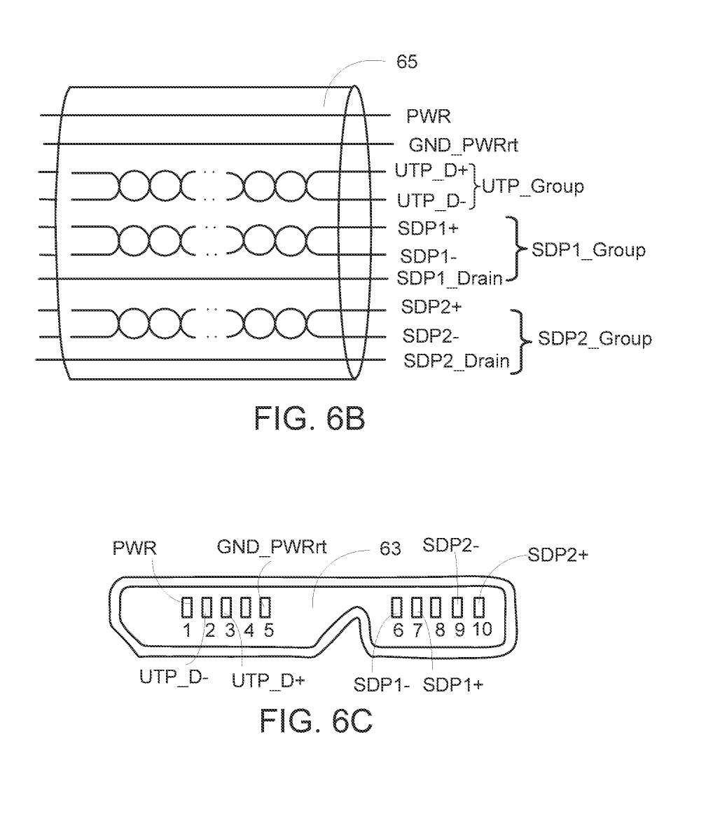

FIG. 6A shows a schematic view of a signal transmission line applied with a standard type A connector according to one embodiment of the present disclosure. The host connector is a USB 3.0 compliant type A connector. The host connector 61 includes two rows of contacts. In general, these contacts may be made of a conductive material such as gold, silver or copper. When the host connector 61 is connected to a host such as a personal computer, data from a device are transmitted to the host via the cable and the contacts.

According to definitions of a standard type A host connector, the contact points at the front row near the outer side are connected to wires adopting the USB 2.0 standard. The contacts at the front row, from left to right, are a fourth contact, a third contact, a second contact and a first contact connected to the ground wire (GND_PWRrt), the high speed negative wire (UTP_D−), the high speed positive wire (UTP_D+) and the power wire (PWR), respectively,

Further, the contacts at the rear row near the inner side are connected to wires defined by USB 3.0. The super speed positive receiving wire (SDP2+), the super speed negative receiving wire (SDP2−), the super speed positive transmitting wire (SDP1+) and the super speed negative transmitting wire (SDP1−) are connected to a ninth contact, an eighth contact, a sixth contact and a fifth contact, respectively.

FIG. 6B shows a schematic diagram of a signal transmission line according to an embodiment of the present disclosure. Referring to FIG. 6B, a signal transmission line 65 according to an embodiment includes multiple USB 2.0 compliant high speed wires (UTP_D+ and UTP_D−), and multiple USB 3.0 compliant super speed wires (SDP1+, SDP1−, SDP1_Drain, SDP2+, SDP2−, and SDP2_Drain). The signal transmission line 65 further includes a power wire (PWR) and a ground wire (GND_PWRrt).

The high speed wires, the super speed wires, the power wire (PWR) and the ground wire (GND_PWRrt) are adjacent and parallel to one another. Further, the high speed wires, the super speed wires, the power wire and the ground wire are flexible and jointly form a bundle. The signal transmission line further includes a conductive tape or a metal layer enveloping the bundle.

The high speed wires transceive data by half duplex between the host and the device. The super speed wires are parallel to the high speed wires. The super speed wires transceive data by full duplex between the host and the device.

As described above, a signal transmission line and a cable applied for the USB 3.0 standard are provided by the present disclosure. The cable includes a host connector selectively electrically coupled to a host end, a device connector selectively electrically coupled to a device, and a signal transmission line having one end electrically coupled to the host connector and the other end electrically coupled to the device connector.

According to a concept of the present disclosure, the signal transmission line has one end electrically coupled to the host connector as shown in FIG. 6A, and the other end selectively connected to the device connector or a dedicated circuit of the device. For example, when a USB 3.0 wireless NIC is developed by a manufacturer, the signal transmission line 65 may have one end connected to a host connector for data communication with a host, and the other end electrically coupled to a printed circuit board (PCB) providing a wireless MC function.

The host connector may be a standard type A host connector, or another type of connector defined by USB 3.0. Further, the other end of the signal transmission line may be determined by definitions on the PCB layout. As the signal transmission line 65 according to the embodiment has a smaller outer diameter, the signal transmission line 65 can be easily connected to a PCB having a function circuit even if the USB device has limited internal space.

A USB 3.0 signal transmission line implementing the details of the present disclosure is capable of significantly reducing its overall length. For example, the length of the signal transmission line including a welding section can be reduced to approximately 3.5 cm, with the length of the signal transmission line alone being reduced to approximately 1.8 cm.

Further, a manufactured USB 3.0 compliant cable can be electrically coupled to any type of USB 3.0 host connectors and USB 3.0 device connectors. A USB 3.0 cable provided by the present disclosure has a smaller diameter, and is capable of satisfying and maintaining functions defined by the USB 3.0 standard.

FIG. 6C shows a schematic diagram of a micro B device connector applied with a signal transmission line according to an embodiment of the present disclosure. In the diagram, the micro B device connector is USB 3.0 compliant. It should be noted that, a device connector applied with the signal transmission line 65 is not limited to the micro B device connector. In FIG. 6C, five contacts at the left (contacts 1 to 5) are connected to wires defined according to the USB 2.0 standard; five contacts at the right (contacts 6 to 10) are connected to additional wires defined according to the USB 3.0 standard.

As seen from the left side of FIG. 6C, the first contact of the micro B device connector is connected to the power wire (PWR), the second contact is connected to the high speed positive wire (UTP_D+), the third contact is connected to the high speed negative wire (UTP_D−), and the fifth contact is connected to the ground wire (GND_PWRrt).

As seen from the right side of FIG. 6C, the sixth contact of the micro B device connector is connected to the super speed negative transmitting wire (SDP1−), the seventh contact is connected to the super speed positive transmitting wire (SDP1+), the ninth contact is connected to the super speed negative receiving wire (SDP2−), and the tenth contact is connected to the super speed positive receiving wire (SDP2+).

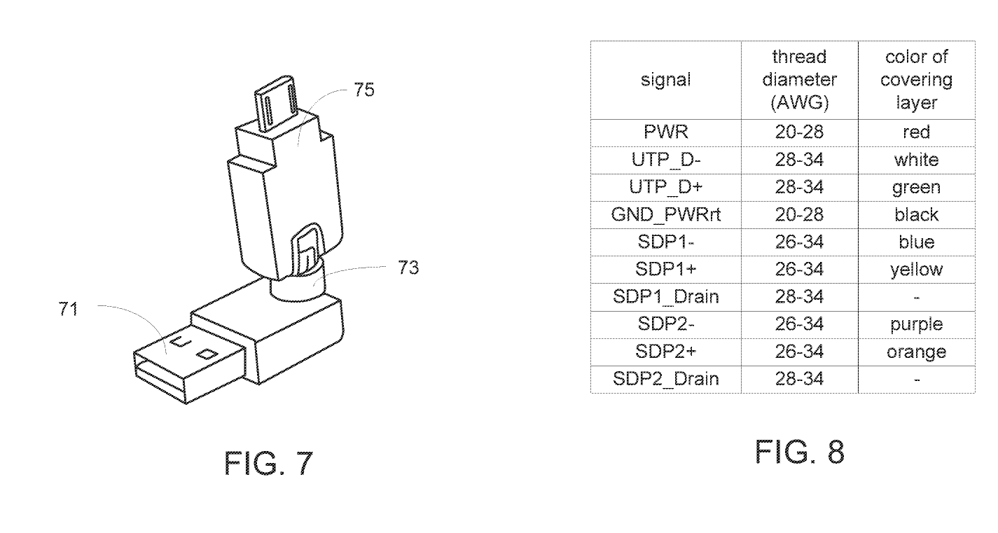

FIG. 7 shows a schematic diagram of a signal transmission line that can be readily put to storage. In FIG. 7, the USB 3.0 cable is applied with a standard type A host connector and a standard type B device connector. Further, the signal transmission line can be stored between the host connector and the device connector. A cable adopting the concept of the present disclosure has a smaller overall thread diameter. Thus, for external connection purposes, a USB 3.0 cable with such design can be more readily put to storage or organized.

American Wire Gauge (hereinafter, AWG) is a unit for measuring a thread diameter. As the value of AWG get smaller, the thread diameter gets larger for carrying a greater current. Conversely, as the value of AWG gets larger, the thread diameter gets smaller and the current that can be withstood by the smaller thread diameter also gets smaller. Hence, in one embodiment of the present disclosure, a wire having a greater AWG value can be selected as internal signal wires.

FIG. 8 shows a schematic diagram of selectable thread diameter ranges and colors of covers based on the USB 3.0 standard. According to USB 3.0 definitions, the power wire (PWR) has a thread diameter range of 20 to 28 AWG, and a cover in red. Further, according to USB 3.0 definitions, the high speed negative wire (UTP_D−) and the high speed positive wire (UTP_D+) both have a thread diameter range of 28 AWG to 34 AWG. The high speed negative wire (UTP_D−) has a cover in white, and the high speed positive wire (UTP_D+) has a cover in green. Further, according to USB 3.0 definitions, the ground wire (GND_PWRrt) has a thread diameter range of 20 AWG to 28 AWG, and a cover in black.

Further, according to USB 3.0 definitions, the super speed negative transmitting wire (SDP1−) and the super speed positive transmitting wire (SDP1+) both have a thread diameter range of 26 AWG to 34 AWG, and the super speed transmitting shielded wire (SDP1_Drain) has a thread diameter range of 28 AWG to 34 AWG. The super speed negative transmitting wire (SDP1−) has a cover in blue, and the super speed positive transmitting wire (SDP1+) has a cover in yellow.

Further, according to USB 3.0 definitions, the super speed negative receiving wire (SDP2−) and the super speed positive receiving wire (SDP2+) both have a thread diameter range of 26 AWG to 34 AWG, and the super speed receiving shielded wire (SDP2_Drain) has a thread diameter range of 28 AWG to 34 AWG. The super speed negative receiving wire (SDP2−) has a cover in purple, and the super speed positive receiving wire (SDP2+) has a cover in orange.

In one embodiment of the present disclosure, wires having smaller thread diameters may be utilized in the signal transmission line according to the specifications on thread diameters defined by USB 3.0. For example, a thread diameter 28 AWG is selected for the power wire (PWR) and the ground wire (GND_PWRrt), and a thread diameter 34 AWG is selected for the high speed negative wire (UTP_D−), the high speed positive wire (UTP_D+), the super speed negative transmitting wire (SDP1−), the super speed positive transmitting wire (SDP1), the super speed transmitting shielded wire (SDP1_Drain) the super speed negative receiving wire (SDP2−), the super speed positive receiving wire (SDP2+), and the super speed receiving shielded wire (SDP2_Drain).

According to one embodiment of the present disclosure, an overall thread diameter of a USB 3.0 compliant signal transmission line may be reduced to 1.7 mm. Thus, the USB 3.0 compliant signal transmission line and cable of the present disclosure offer a reduced overall thread diameter, and are thus flexible for easy storage and manageability.

While the disclosure has been described by way of example and in terms of the preferred embodiments, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A signal transmission line, connected to a host via a host connector, comprising:
a plurality of high speed wires, for transceiving data by half duplex via the host connector;
a plurality of super speed wires, parallel to the plurality of high speed wires, for transceiving data by full duplex via the host connector;
a power wire, parallel to the plurality of high speed wires and the plurality of super speed wires;
a ground wire, parallel to the plurality of high speed wires and the plurality of super speed wires, wherein the plurality of high speed wires, the plurality of super speed wires, the power wire, and the ground wire form a bundle; and
an external conductive layer, enveloping the bundle.

2. The signal transmission line according to claim 1, wherein the external conductive layer is a conductive tape or a metal layer.

3. The signal transmission line according to claim 1, wherein the plurality of super speed wires comprise:
a super speed positive transmitting wire;
a super speed negative transmitting wire, forming, with the super speed positive transmitting wire, a first full duplex differential pair for transmitting data of the host to a device;
a super speed transmitting shielded wire, serving as a ground of the first full duplex differential pair;
a super speed positive receiving wire;
a super speed negative receiving wire, forming, with the super speed positive receiving wire, a second full duplex differential pair for receiving data from the device to the host; and
a super speed receiving shielded wire, serving as a ground of the second full duplex differential pair.

4. The signal transmission line according to claim 3, wherein the super speed positive transmitting wire, the super speed negative transmitting wire and the super speed transmitting shielded wire are adjacent to one another and form a super speed transmitting wire group; and the super speed positive receiving wire, the super speed negative receiving wire and the super speed receiving shielded wire are adjacent to one another and form a super speed receiving wire group.

5. The signal transmission line according to claim 4, further comprising:
a first internal conductive layer, enveloping the super speed transmitting wire group; and
a second internal conductive layer, enveloping the super speed receiving wire group.

6. The signal transmission line according to claim 5, wherein each of the first and the second internal conductive layers is a metal layer or a conductive tape.

7. The signal transmission line according to claim 6, wherein the metal layer is aluminum foil or copper foil.

8. The signal transmission line according to claim 1, wherein each of the high speed wires, the super speed positive transmitting wire, the super speed negative transmitting wire, the super speed positive receiving wire and the super speed negative receiving wire comprises a core made of a conductive material, and a cover made of an insulation material and for enveloping the core.

9. The signal transmission line according to claim 1, wherein the host connector is a USB 3.0 compliant type A connector.

10. The signal transmission line according to claim 1, wherein the signal transmission line is further connected to a device connector or a dedicated circuit of a device.

11. The signal transmission line according to claim 10, wherein the device connector is a USB 3.0 compliant type B connector.

12. A cable for Universal Serial Bus (USB), comprising:
a host connector, selectively electrically coupled to a host;
a device connector, selectively electrically coupled to a device; and
a signal transmission line, having one end electrically coupled to the host connector and the other end electrically coupled to the device connector, comprising:
a plurality of high speed wires, for transceiving data between the host and the device by half duplex;
a plurality of super speed wires, parallel to the plurality of high speed wires, for transceiving data between the host and the device by full duplex;
a power wire, parallel to the plurality of high speed wires and the plurality of super speed wires;
a ground wire, parallel to the plurality of high speed wires and the plurality of super speed wires; wherein, the plurality of high speed wires, the plurality of super speed wires, the power wire and the ground wire form a bundle; and
an external conductive layer, enveloping the bundle.

13. The cable according to claim 12, wherein the external conductive layer is a conductive tape or a metal layer.

14. The cable according to claim 12, wherein the plurality of super speed wires comprise:
a super speed positive transmitting wire;
a super speed negative transmitting wire, forming, with the super speed positive transmitting wire, a first full duplex differential pair for transmitting data of the host to the device;
a super speed transmitting shielded wire, serving as a ground of the first full duplex differential pair;
a super speed positive receiving wire;
a super speed negative receiving wire, forming, with the super speed positive receiving wire, a second full duplex differential pair for receiving data from the device to the host; and
a super speed receiving shielded wire, serving as a ground of the second full duplex differential pair.

15. The cable according to claim 14, wherein:
the super speed positive transmitting wire, the super speed negative transmitting wire and the super speed transmitting shielded wire are adjacent to one another, and form a super speed transmitting wire group; and
the super speed positive receiving wire, the super speed negative receiving wire and the super speed receiving shielded wire are adjacent to one another, and form a super speed receiving wire group.

16. The cable according to claim 15, wherein the signal transmission line further comprises:
a first internal conductive layer, enveloping the super speed transmitting wire group; and
a second internal conductive layer, enveloping the super speed receiving wire group,

17. The cable according to claim 12, wherein each of the high speed wires, the super speed positive transmitting wire, the super speed negative transmitting wire, the super speed positive receiving wire and the super speed negative receiving wire comprises a core made of a conductive material, and a cover made of an insulation material and for enveloping the core.

18. The cable according to claim 12, wherein the host connector is a USB 3.0 compliant type A connector, and the device connector is a USB 3.0 compliant type B connector.
